(19) United States
(12) Patent Application Publication
(10) Pub. No.: US 2005/0064351 A1
(43) Pub. Date: Mar. 24, 2005

(54) Silver-halide-containing photothermographic element for improved latitude

(75) Inventors: Alfred P. Marchetti, Penfield, NY (US); Roger A. Bryant, Rochester, NY (US); Jeri L. Mount, Rochester, NY (US); Gregg P. Bryant, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/666,881

(22) Filed: Sep. 19, 2003

(51) Int. Cl. G03C 1/00

(52) U.S. Cl. 430/619

(57) ABSTRACT

The present invention is directed to a photothermographic element comprising a fine grain silver halide emulsion sensitized with less than about 40,000 atoms of sulfur and less than about 6,000 atoms of gold per square micron of grain surface area.

### FIELD OF THE INVENTION

The present invention is directed to a silver-halide-containing photothermographic element for improved exposure latitude. The invention is further directed to a photothermographic material comprising improved sensitized fine-grain silver halide light-sensitive emulsion.

### BACKGROUND OF THE INVENTION

The photographic arts have a longstanding history of attempts to supply customers with convenient and simple ways to take pictures that serve to record their everyday lives. Conventional color photography has attempted to meet this need by supplying light sensitive silver halide containing films suitable for use in hand-held cameras. Upon exposure, the film carries a latent image that is only revealed after suitable processing. These elements have historically been processed by treating the camera-exposed film with at least a developing solution, a bleaching solution, a fixing solution, and a rinse solution. As the desire for more rapid access, greater availability of processing opportunities, and more environmentally compatible process increases, a completely dry processing system has been sought.

By the use of photothermographic film, it would be possible to eliminate processing solutions altogether, or alternatively, to minimize the amount of processing solutions and the complex chemicals contained therein. Development is the process whereby silver ion is reduced to metallic silver and in a color system, a dye is created in an image-wise fashion. A photothermographic (PTG) film by definition is a film that requires energy, typically heat, to effect development. A dry PTG film requires only heat for development; a solution-minimized PTG film may require small amounts of aqueous alkaline solution to effect development. Such small amounts may be only that required to swell the film, excluding excess solution.

Recently, Slusarek et al., European Patent Application 1,164,418A, disclosed photothermographic elements containing blocked photographic developers released by a thermal treatment. Thus, a simple and convenient process to develop images in a silver-halide photosensitive material has been provided. Also disclosed is the use of conventional emulsions comprising silver bromoidide grains in the photosensitive material in combination with the blocked developer, melt former, organic silver salts, and binder.

In addition to simple and convenient dry processing, photographers desire a photographic film capable of capturing the wide variety of scene luminance encountered in everyday photographic situations. Typical color negative photographic films employ multiple layers comprising silver-halide emulsion grains of different sensitivities in each color recording layer unit. Finer grain-size emulsions are employed for the lower sensitivity layers in order to minimize the granularity of the image. A fine-grained emulsion is defined as a grain with an average surface area per grain of less than 1.0 micron squared.

In the silver-halide photographic art, the process of chemical sensitization to achieve improved emulsion grain sensitivity is well known. Insufficient amounts of sensitizing compounds in the emulsion sensitization process may result in poor photosensitivity. Excessive amounts of sensitizing compounds may result in unacceptable levels of minimum density (fog) when the material is exposed and subjected to photographic processing to provide an image. Sensitizing compounds typically contain either chalcogen atoms and/or noble metal atoms that react in the presence of the silver-halide grains of the emulsion to provide sensitivity centers. Optimal sensitization of both large and fine grain emulsions for a color negative film intended for a traditional aqueous color process such as the C-41 process are disclosed by Eikenberry in U.S. Pat. No. 6,296,998. The finer grains require higher levels of sensitizer per unit of grain surface area to achieve optimal sensitization.

Eshelman et al., in U.S. Pat. No. 5,843,632, disclose that relatively high levels of sensitizers were required for a fine-grain emulsion sensitized in either aqueous gelatin or non-aqueous medium and evaluated in a solvent-coated photothermographic material.

Fine grain emulsions of the type usually employed for the slowest layers of a color negative film have been evaluated in a photothermographic system and found to produce undesirable levels of fog upon processing. In this case, the latitude, or useful photographic exposure range of the film, is reduced. Thus, there remains a need to produce sensitized fine grain emulsion providing low fog and improved latitude for a color negative photothermographic film.

It is an object of the present invention to improve the latitude of photothermographic film by employing sensitized fine silver halide grains with low levels of fog.

### SUMMARY OF THE INVENTION

The present invention is directed to a color photothermographic material comprising a fine-grain silver-halide light-sensitive emulsion sensitized with an effective amount less than about 40,000 atoms of sulfur and an effective amount less than about 6,000 atoms of gold per square micron of emulsion surface area. Surprisingly, we have found that silver-halide emulsions comprising sensitizers at or below these levels provide both high sensitivity and low fog when incorporated in a photothermographic element for heat processing.

The present invention is also directed to a method of processing a color photothermographic element.

### DETAILED DESCRIPTION OF THE INVENTION

The silver halide used in the photographic elements (including photothermographic) may be silver iodobromide, silver bromide, silver chloride, silver chlorobromide, silver chloroiodobromide, and the like. Most commonly high bromide emulsions containing a minor amount of iodide are employed in color negative film. The grain size of the silver halide may have any distribution known to be useful in photographic compositions, and may be either polydispersed or monodispersed.

The silver-halide grains to be used in the invention may be prepared according to methods known in the art, such as those described in Research Disclosure, 38957 (September 1996), Part 1, and The Theory of the Photographic Process, 4^{th} edition, T. H. James, editor, Macmillan Publishing Co., New York, 1977. These include methods such as ammoniacal emulsion making, neutral or acidic emulsion making, and others known in the art. These methods generally involve mixing a water-soluble silver salt with a water-soluble halide salt in the presence of a protective colloid, and controlling the temperature, pAg, pH values, etc, at suitable values during formation of the silver halide by precipitation.

Especially useful in this invention are radiation-sensitive tabular grain silver halide emulsions. Tabular grains are silver halide grains having parallel major faces and an aspect ratio of at least 2, where aspect ratio is the ratio of grain equivalent circular diameter (ECD) divided by grain thickness (t). The equivalent circular diameter of a grain is the diameter of a circle having an average equal to the projected area of the grain. A tabular grain emulsion is one in which tabular grains account for greater than 50 percent of total grain projected area. In preferred emulsions, tabular grains account for at least 70 percent of total grain projected area and optimally at least 90 percent of total grain projected area. It is possible to prepare tabular grain emulsions in which substantially all (>97%) of the grain projected area is accounted for by tabular grains. The non-tabular grains in a tabular grain emulsion can take any convenient conventional form.

The tabular grain emulsions can be either high bromide or high chloride emulsions. High bromide emulsions are those in which silver bromide accounts for greater than 50 mole percent of total halide, based on silver. High chloride emulsions are those in which silver chloride accounts for greater than 50 mole percent of total halide, based on silver. Silver bromide and silver chloride both form a face centered cubic crystal lattice structure. This silver halide crystal lattice structure can accommodate all proportions of bromide and chloride ranging from silver bromide with no chloride present to silver chloride with no bromide present. Thus, silver bromide, silver chloride, silver bromochloride and silver chlorobromide tabular grain emulsions are all specifically contemplated.

In naming grains and emulsions containing two or more halides, the halides are named in order of ascending concentrations. Usually high chloride and high bromide grains that contain bromide or chloride, respectively, contain the lower level halide in a more or less uniform distribution. However, non-uniform distributions of chloride and bromide are known, as illustrated by Maskasky U.S. Pat. Nos. 5,508,160 and 5,512,427 and Delton U.S. Pat. Nos. 5,372,927 and 5,460,934, the disclosures of which are here incorporated by reference.

It is recognized that the emulsion grains can accommodate iodide up to its solubility limit in the face centered cubic crystal lattice structure of the grains. The solubility limit of iodide in a silver bromide crystal lattice structure is approximately 40 mole percent, based on silver. The solubility limit of iodide in a silver chloride crystal lattice structure is approximately 11 mole percent, based on silver. The exact limits of iodide incorporation can be somewhat higher or lower, depending upon the specific technique employed for silver halide grain preparation. In practice, useful photographic performance advantages can be realized with iodide concentrations as low as 0.1 mole percent, based on silver. It is usually preferred to incorporate at least 0.5 (optimally at least 1.0) mole percent iodide, based on silver. Only low levels of iodide are required to realize significant emulsion speed increases. Higher levels of iodide are commonly incorporated to achieve other photographic effects, such as interimage effects. Overall iodide concentrations of up to 20 mole percent, based on silver, are well known, but it is generally preferred to limit iodide to 15 mole percent, more preferably 10 mole percent, or less, based on silver. Higher than needed iodide levels are generally avoided, since it is well recognized that iodide slows the rate of silver halide development.

Iodide can be uniformly or non-uniformly distributed within the emulsion grains. Both uniform and non-uniform iodide concentrations are known to contribute to photographic speed. For maximum speed it is common practice to distribute iodide over a large portion of a tabular grain while increasing the local iodide concentration within a limited portion of the grain. It is also common practice to limit the concentration of iodide at the surface of the grains. Preferably the surface iodide concentration of the grains is less than 5 mole percent, based on silver. Surface iodide is the iodide that lies within 0.02 nm of the grain surface.

With iodide incorporation in the grains, the high chloride and high bromide tabular grain emulsions within the contemplated scope of the invention extend to silver iodobromide, silver iodochloride, silver iodochlorobromide and silver iodobromochloride tabular grain emulsions.

When tabular grain emulsions are spectrally sensitized, as herein contemplated, it is preferred to limit the average thickness of the tabular grains to less than 0.3 μm. Most preferably the average thickness of the tabular grains is less than 0.2 μm. In a specific preferred form the tabular grains are ultrathin—that is, their average thickness is less than 0.07 μm.

The useful average grain ECD of a tabular grain emulsion can range up to about 15 μm. For the fine-grain applications of the present invention, the average surface area is 1 micron squared or less, corresponding to an ECD less than 0.8 micron. The average aspect ratio of the tabular grain emulsions can vary widely, since it is quotient of ECD divided by grain thickness. Most tabular grain emulsions have average aspect ratios of greater than 5, with high (>8) average aspect ratio emulsions being generally preferred.

The tabular grains can have parallel major faces that lie in either {100} or {111} crystal lattice planes. In other words, both {111} tabular grain emulsions and {100} tabular grain emulsions are within the specific contemplation of this invention. The {111} major faces of {111} tabular grains appear triangular or hexagonal in photomicrographs while the {100} major faces of {100} tabular grains appear square or rectangular.

High chloride {111} tabular grain emulsions are illustrated by Wey U.S. Pat. No. 4,399,215, Wey et al U.S. Pat. No. 4,414,306, Maskasky U.S. Pat. Nos. 4,400,463, 4,713,323, 5,061,617, 5,178,997, 5,183,732, 5,185,239, 5,399,478 and 5,411,852, Maskasky et al U.S. Pat. Nos. 5,176,992 and 5,178,998, Takada et al. U.S. Pat. No. 4,783,398, Nishikawa et al U.S. Pat. No. 4,952,508, Ishiguro et al U.S. Pat. No. 4,983,508, Tufano et al U.S. Pat. No. 4,804,621, Maskasky and Chang U.S. Pat. No. 5,178,998, and Chang et al U.S. Pat. No. 5,252,452. Ultrathin high chloride {111} tabular grain emulsions are illustrated by Maskasky U.S. Pat. Nos. 5,271,858 and 5,389,509.

Since silver chloride grains are most stable in terms of crystal shape with {100} crystal faces, it is common practice to employ one or more grain growth modifiers during the formation of high chloride {111} tabular grain emulsions. Typically the grain growth modifier is displaced prior to or during subsequent spectral sensitization, as illustrated by Jones et al U.S. Pat. No. 5,176,991 and Maskasky U.S. Pat. Nos. 5,176,992, 5,221,602, 5,298,387 and 5,298,388, the disclosures of which are here incorporated by reference.

Preferred high chloride tabular grain emulsions are {100} tabular grain emulsions, as illustrated by the following patents, here incorporated by reference: Maskasky U.S. Pat. Nos. 5,264,337, 5,292,632, 5,275,930, 5,607,828 and 5,399,477, House et al U.S. Pat. No. 5,320,938, Brust et al U.S. Pat. No. 5,314,798, Szajewski et al U.S. Pat. No. 5,356,764, Chang et al U.S. Pat. Nos. 5,413,904, 5,663,041, and 5,744,297, Budz et al U.S. Pat. No. 5,451,490, Reed et al U.S. Pat. No. 5,695,922, Oyamada U.S. Pat. No. 5,593,821, Yamashita et al U.S. Pat. Nos. 5,641,620 and 5,652,088, Saitou et al U.S. Pat. No. 5,652,089, and Oyamada et al U.S. Pat. No. 5,665,530. Ultrathin high chloride {100} tabular grain emulsions can be prepared by nucleation in the presence of iodide, following the teaching of House et al and Chang et al, cited above. Since high chloride {100} tabular grains have {100} major faces and are, in most instances, entirely bounded by {100} grain faces, these grains exhibit a high degree of grain shape stability and do not require the presence of any grain growth modifier for the grains to remain in a tabular form following their precipitation.

In their most widely used form tabular grain emulsions are high bromide {111} tabular grain emulsions. Such emulsions are illustrated by Kofron et al U.S. Pat. No. 4,439,520, Wilgus et al U.S. Pat. No. 4,434,226, Solberg et al U.S. Pat. No. 4,433,048, Maskasky U.S. Pat. Nos. 4,435,501, 4,463,087 4,173,320 and 5,411,851 5,418,125, 5,492,801, 5,604,085, 5,620,840, 5,693,459, 5,733,718, Daubendiek et al U.S. Pat. Nos. 4,414,310 and 4,914,014, Sowinski et al U.S. Pat. No. 4,656,122, Piggin et al U.S. Pat. Nos. 5,061,616 and 5,061,609, Tsaur et al U.S. Pat. Nos. 5,147,771, '772, '773, 5,171,659 and 5,252,453, Black et al 5,219,720 and 5,334,495, Delton U.S. Pat. Nos. 5,310,644, 5,372,927 and 5,460,934, Wen U.S. Pat. No. 5,470,698, Fenton et al U.S. Pat. No. 5,476,760, Eshelman et al U.S. Pat. Nos. 5,612,175, 5,612,176 and 5,614,359, and Irving et al U.S. Pat. Nos. 5,695,923, 5,728,515 and 5,667,954, Bell et al U.S. Pat. No. 5,132,203, Brust U.S. Pat. Nos. 5,248,587 and 5,763,151, Chaffee et al U.S. Pat. No. 5,358,840, Deaton et al U.S. Pat. No. 5,726,007, King et al U.S. Pat. No. 5,518,872, Levy et al U.S. Pat. No. 5,612,177, Mignot et al U.S. Pat. No. 5,484,697, Olm et al U.S. Pat. No. 5,576,172, Reed et al U.S. Pat. Nos. 5,604,086 and 5,698,387.

Ultrathin high bromide {111} tabular grain emulsions are illustrated by Daubendiek et al U.S. Pat. Nos. 4,672,027, 4,693,964, 5,494,789, 5,503,971 and 5,576,168, Antoniades et al U.S. Pat. No. 5,250,403, Olm et al U.S. Pat. No. 5,503,970, Deaton et al U.S. Pat. No. 5,582,965, and Maskasky U.S. Pat. No. 5,667,955.

High bromide {100} tabular grain emulsions are known, as illustrated by Mignot U.S. Pat. Nos. 4,386,156 and 5,386,156 and Gourlaouen et al U.S. Pat. No. 5,726,006.

In many of the patents listed above (starting with Kofron et al, Wilgus et al and Solberg et al, cited above) speed increases without accompanying increases in granularity are realized by the rapid (a.k.a. dump) addition of iodide for a portion of grain growth. Chang et al U.S. Pat. No. 5,314,793 correlates rapid iodide addition with crystal lattice disruptions observable by stimulated emission profiles.

Localized peripheral incorporations of higher iodide concentrations can also be created by halide conversion. By controlling the conditions of halide conversion by iodide, differences in peripheral iodide concentrations at the grain corners and elsewhere along the edges can be realized. For example, Fenton et al U.S. Pat. No. 5,476,76 discloses lower iodide concentrations at the corners of the tabular grains than elsewhere along their edges. Jagannathan et al U.S. Pat. Nos. 5,723,278 and 5,736,312 disclose halide conversion by iodide in the corner regions of tabular grains.

Crystal lattice dislocations, although seldom specifically discussed, are a common occurrence in tabular grains. For example, examinations of the earliest reported high aspect ratio tabular grain emulsions (e.g., those of Kofron et al, Wilgus et al and Solberg et al, cited above) reveal high levels of crystal lattice dislocations. Black et al U.S. Pat. No. 5,709,988 correlates the presence of peripheral crystal lattice dislocations in tabular grains with improved speed-granularity relationships. Ikeda et al U.S. Pat. No. 4,806,461 advocates employing tabular grain emulsions in which at least 50 percent of the tabular grains contain 10 or more dislocations. For improving speed-granularity characteristics, it is preferred that at least 70 percent and optimally at least 90 percent of the tabular grains contain 10 or more peripheral crystal lattice dislocations.

The silver halide emulsion may comprise tabular silver halide grains having surface chemical sensitization sites including at least one silver salt forming epitaxial junction with the tabular grains and being restricted to those portions of the tabular grains located nearest peripheral edges.

The silver halide tabular grains of the photographic material may be prepared with a maximum surface iodide concentration along the edges and a lower surface iodide concentration within the corners than elsewhere along the edges.

In the course of grain precipitation one or more dopants (grain occlusions other than silver and halide) can be introduced to modify grain properties. For example, any of the various conventional dopants disclosed in Research Disclosure, Item 38957, Section I. Emulsion grains and their preparation, sub-section G. Grain modifying conditions and adjustments, paragraphs (3), (4) and (5), can be present in the emulsions of the invention. Especially useful dopants are disclosed by Marchetti, et al., U.S. Pat. No. 4,937,180, and Johnson, et al., U.S. Pat. No. 5,164,292. In addition it is specifically contemplated to dope the grains with transition metal hexacoordination complexes containing one or more organic ligands, as taught by Olm et al U.S. Pat. No. 5,360,712, the disclosure of which is here incorporated by reference.

It is specifically contemplated to incorporate in the face centered cubic crystal lattice of the grains a dopant capable of increasing imaging speed by forming a shallow electron trap (hereinafter also referred to as a SET) as discussed in Research Disclosure Item 36736 published November 1994, here incorporated by reference.

SET dopants are known to be effective to reduce reciprocity failure. In particular, the use of Group VIII hexacoordination complexes with 3 or more CN ligands, as SET dopants is advantageous. Examples include Fe(CN)₆³⁻, Fe(CN)₆⁴⁻, Ru(CN)₆⁴⁻, Os(CN)₆⁴, Fe(CN)₅CO³⁻, Fe(CN)₅ 4,4′ bipyridine³⁻, and Os(CN)₅ 4,4′ bipyridine³⁻. Additionally, the Ir(CN)₆³⁻ and Rh(CN)₆³⁻ can be used as SET dopants.

Iridium dopants that are ineffective to provide shallow electron traps (non-SET dopants) can also be incorporated into the grains of the silver halide grain emulsions to reduce reciprocity failure. Other examples of iridium complexes which can be used to reduce reciprocity failure include the complexes IrCl₆³⁻, IrCl₆²⁻, IrCl₅H₂O²⁻, IrCl₅5-methyl-thiazole²⁻, and IrCl₅thiazole²⁻.

The contrast of the photographic element can be further increased by doping the grains with a hexacoordination complex containing a nitrosyl or thionitrosyl ligand (NZ dopants) as disclosed in McDugle et al U.S. Pat. No. 4,933,272, the disclosure of which is here incorporated by reference. Examples of other contrast enhancing dopants which can be used are RbCl₆³⁻, RhCl₅H₂₀²⁻, RhCl₄H₂O₂¹⁻, and RhBr₆³⁻.

According to the present invention, a color photothermographic element for accurately recording a scene as an image comprising a support and coated on the support a plurality of hydrophilic colloid layers comprising radiation sensitive silver-halide emulsion layers forming recording layer units for separately recording blue, green, and red exposures comprises a limited amount of silver halide in the element. While any useful quantity of light sensitive silver, as silver halide, can be employed in the elements useful in this invention, it is preferred that the total quantity be not more than 4.5 g/m² of silver, preferably less. Silver quantities of less than 4.0 g/m² are preferred, and silver quantities of less than 3.5 g/m² are even more preferred. The lower quantities of silver improve the optics of the elements, thus enabling the production of sharper pictures using the elements. These lower quantities of silver are additionally important in that they enable rapid development and desilvering of the elements. Conversely, a silver coating coverage of at least 1.0 g of coated silver per m² of support surface area in the element is necessary to realize an exposure latitude of at least 2.7 log E while maintaining an adequately low graininess position for pictures intended to be enlarged. Silver coverages in excess of 1.5 g/m² are preferred while silver coverages in excess of 2.5 g/m² are more preferred.

In one embodiment of the invention, the silver halide is low reflectivity silver halide having a grain thickness >0.06, preferably >0.08, more preferable >0.10 microns.

In another embodiment of the invention, the color photothermographic element of claim comprises an organic silver donor and the fraction of silver as silver halide relative to total silver, including both silver halide and silver donor, is from 30 to 85%, preferable 50 to 80%, more preferably 55 to 75% by weight. These organic silver donors are typically not light sensitive.

A typical color negative film construction useful in the practice of the invention is illustrated by the following element, SCN-1:

Element SCN-1

| | |
|---|---|
| SOC | Surface Overcoat |
| BU | Blue Recording Layer Unit |
| IL1 | First Interlayer |
| GU | Green Recording Layer Unit |
| IL2 | Second Interlayer |
| RU | Red Recording Layer Unit |
| AHU | Antihalation Layer Unit |
| S | Support |
| SOC | Surface Overcoat |

The support S can be either reflective or transparent, which is usually preferred. When reflective, the support is white and can take the form of any conventional support currently employed in color print elements. When the support is transparent, it can be colorless or tinted and can take the form of any conventional support currently employed in color negative elements—e.g., a colorless or tinted transparent film support. Details of support construction are well understood in the art. Examples of useful supports are poly(vinylacetal) film, polystyrene film, poly(ethyleneterephthalate) film, poly(ethylene naphthalate) film, polycarbonate film, and related films and resinous materials, as well as paper, cloth, glass, metal, and other supports that withstand the anticipated processing conditions. The element can contain additional layers, such as filter layers, interlayers, overcoat layers, subbing layers, antihalation layers and the like. Transparent and reflective support constructions, including subbing layers to enhance adhesion, are disclosed in Section XV of Research Disclosure, September 1996, Number 389, Item 38957 (hereafter referred to as (“Research Disclosure I”).

Photothermographic elements of the present invention may also usefully include a magnetic recording material as described in Research Disclosure, Item 34390, November 1992, or a transparent magnetic recording layer such as a layer containing magnetic particles on the underside of a transparent support as in U.S. Pat. No. 4,279,945, and U.S. Pat. No. 4,302,523.

Each of blue, green and red recording layer units BU, GU and RU are formed of one or more hydrophilic colloid layers and contain at least one radiation-sensitive silver halide emulsion and coupler, including at least one dye image-forming coupler. It is preferred that the green and red recording units are subdivided into at least two recording layer sub-units to provide increased recording latitude and reduced image granularity. In the simplest contemplated construction, each of the layer units or layer sub-units consists of a single hydrophilic colloid layer containing emulsion and coupler. When coupler present in a layer unit or layer sub-unit is coated in a hydrophilic colloid layer other than an emulsion containing layer, the coupler containing hydrophilic colloid layer is positioned to receive oxidized color developing agent from the emulsion during development. Usually the coupler containing layer is the next adjacent hydrophilic colloid layer to the emulsion containing layer.

In one embodiment according to the present invention, a color photothermographic film comprises a support, and over the support, at least three light-sensitive units which have their individual sensitivities in different wavelength regions, at least one of the units being divided into at least two recording layer sub-units for increased exposure latitude, wherein each of the layer sub-units comprise a light-sensitive silver-halide emulsion and binder, but wherein the two layer sub-units differ in speed. The first of the two recording layer sub-units has a relatively lower speed than the second of the two recording layer subunits and, in the silver-halide emulsion of the first layer sub-unit, the average surface area per silver halide grain is less than about 1 square micron and the emulsion is sensitized with an effective amount less than about 40,000 atoms of sulfur and with an effective amount less than about 6,000 atoms of gold per square micron of grain surface area. Preferably, in the silver-halide emulsion in the layer sub-unit having a relatively higher speed, the average surface area per silver halide grain is greater than in the relatively lower speed layer sub-unit, and the emulsion is sensitized with an effective amount of sulfur and with an effective amount of gold, per square micron of grain surface area, that is greater than in the relatively lower speed layer sub-unit. More preferably, in the silver-halide emulsion in the layer sub-unit having a relatively higher speed, the average surface area per silver halide grain is substantially greater than in the relatively lower speed layer sub-unit, and the emulsion is sensitized with an effective amount of sulfur and with an effective amount of gold, per square micron of grain surface area, that is substantially greater than in the relatively lower speed layer sub-unit.

For example, in one particular embodiment, the average surface area per silver halide grain is greater than about 1 square micron, and the emulsion is sensitized with an effective amount greater than about 40,000 atoms of sulfur and with an effective amount greater than about 6,000 atoms of gold per square micron of grain surface area in the relatively higher speed silver-halide emulsion of the layer unit.

In order to ensure excellent image sharpness, and to facilitate manufacture and use in cameras, all of the sensitized layers are preferably positioned on a common face of the support. When in spool form, the element will be spooled such that when unspooled in a camera, exposing light strikes all of the sensitized layers before striking the face of the support carrying these layers. Further, to ensure excellent sharpness of images exposed onto the element, the total thickness of the layer units above the support should be controlled. Generally, the total thickness of the sensitized layers, interlayers and protective layers on the exposure face of the support are less than 35 μm. In another embodiment, sensitized layers disposed on two sides of a support, as in a duplitized film, can be employed.

In one embodiment, BU contains at least one yellow dye image-forming coupler, GU contains at least one magenta dye image-forming coupler, and RU contains at least one cyan dye image-forming coupler. Any convenient combination of conventional dye image-forming couplers can be employed. Conventional dye image-forming couplers are illustrated by Research Disclosure I, cited above, X. Dye image formers and modifiers, B. Image-dye-forming couplers. The photographic elements may further contain other image-modifying compounds such as “Development Inhibitor-Releasing” compounds (DIR's). DIR compounds are also disclosed in “Developer-Inhibitor-Releasing (DIR) Couplers for Color Photography,” C. R. Barr, J. R. Thirtle and P. W. Vittum in Photographic Science and Engineering, Vol. 13, p. 174 (1969), incorporated herein by reference.

It is common practice to coat one, two or three separate emulsion layers within a single dye image-forming layer unit. When two or more emulsion layers are coated in a single layer unit, they are typically chosen to differ in sensitivity. When a more sensitive emulsion is coated over a less sensitive emulsion, a higher speed is realized than when the two emulsions are blended. When a less sensitive emulsion is coated over a more sensitive emulsion, a higher contrast is realized than when the two emulsions are blended. It is preferred that the most sensitive emulsion be located nearest the source of exposing radiation and the slowest emulsion be located nearest the support.

One or more of the layer units of the invention is preferably subdivided into at least two, and more preferably three or more sub-unit layers. It is preferred that all light sensitive silver halide emulsions in the color recording unit have spectral sensitivity in the same region of the visible spectrum. In this embodiment, while all silver halide emulsions incorporated in the unit have spectral absorptance according to invention, it is expected that there are minor differences in spectral absorptance properties between them. In still more preferred embodiments, the sensitizations of the slower silver halide emulsions are specifically tailored to account for the light shielding effects of the faster silver halide emulsions of the layer unit that reside above them, in order to provide an imagewise uniform spectral response by the photographic recording material as exposure varies with low to high light levels. Thus higher proportions of peak light absorbing spectral sensitizing dyes may be desirable in the slower emulsions of the subdivided layer unit to account for on-peak shielding and broadening of the underlying layer spectral sensitivity.

When the emulsion layers within a dye image-forming layer unit differ in speed, it is conventional practice to limit the incorporation of dye image-forming coupler in the layer of highest speed to less than a stoichiometric amount, based on silver. The function of the highest speed emulsion layer is to create the portion of the characteristic curve just above the minimum density—i.e., in an exposure region that is below the threshold sensitivity of the remaining emulsion layer or layers in the layer unit. In this way, adding the increased granularity of the highest sensitivity speed emulsion layer to the dye image record produced is minimized without sacrificing imaging speed.

When a layer unit contains two or more emulsion layers differing in speed, it is possible to lower image granularity in the image to be viewed, recreated from an electronic record, by forming in each emulsion layer of the layer unit a dye image which exhibits an absorption half-peak band width that lies in a different spectral region than the dye images of the other emulsion layers of layer unit. This technique is particularly well suited to elements in which the layer units are divided into sub-units that differ in speed. This allows multiple electronic records to be created for each layer unit, corresponding to the differing dye images formed by the emulsion layers of the same spectral sensitivity. The digital record formed by scanning the dye image formed by an emulsion layer of the highest speed is used to recreate the portion of the dye image to be viewed lying just above minimum density. At higher exposure levels second and, optionally, third electronic records can be formed by scanning spectrally differentiated dye images formed by the remaining emulsion layer or layers. These digital records contain less noise (lower granularity) and can be used in recreating the image to be viewed over exposure ranges above the threshold exposure level of the slower emulsion layers. This technique for lowering granularity is disclosed in greater detail by Sutton U.S. Pat. No. 5,314,794, the disclosure of which is here incorporated by reference.

Each layer unit of the color negative elements of the invention produces a dye image characteristic curve gamma of less than 1.5, which facilitates obtaining an exposure latitude of at least 2.7 log E. A minimum acceptable exposure latitude of a multicolor photographic element is that which allows accurately recording the most extreme whites (e.g., a bride's wedding gown) and the most extreme blacks (e.g., a bride groom's tuxedo) that are likely to arise in photographic use. An exposure latitude of 2.6 log E can just accommodate the typical bride and groom wedding scene. An exposure latitude of at least 3.0 log E is preferred, since this allows for a comfortable margin of error in exposure level selection by a photographer. Even larger exposure latitudes are specifically preferred, since the ability to obtain accurate image reproduction with larger exposure errors is realized. Whereas in color negative elements intended for printing, the visual attractiveness of the printed scene is often lost when gamma is exceptionally low, when color negative elements are scanned to create digital dye image records, contrast can be increased by adjustment of the electronic signal information. When the elements of the invention are scanned using a reflected beam, the beam travels through the layer units twice. This effectively doubles gamma (ΔD÷Δlog E) by doubling changes in density (ΔD). Thus, gamma's as low as 1.0 or even 0.6 are contemplated and exposure latitudes of up to about 5.0 log E or higher are feasible. Gammas above 0.25 are preferred and gammas above 0.30 are more preferred. Gammas of between about 0.4 and 0.5 are especially preferred.

The interlayers IL1 and IL2 are hydrophilic colloid layers having as their primary function color contamination reduction-i.e., prevention of oxidized developing agent from migrating to an adjacent recording layer unit before reacting with dye-forming coupler. The interlayers are in part effective simply by increasing the diffusion path length that oxidized developing agent must travel. To increase the effectiveness of the interlayers to intercept oxidized developing agent, it is conventional practice to incorporate oxidized developing agent. Antistain agents (oxidized developing agent scavengers) can be selected from among those disclosed by Research Disclosure I, X. Dye image formers and modifiers, D. Hue modifiers/stabilization, paragraph (2). When one or more silver halide emulsions in GU and RU are high bromide emulsions and, hence have significant native sensitivity to blue light, it is preferred to incorporate a yellow filter, such as Carey Lea silver or a yellow processing solution decolorizable dye, in IL1. Suitable yellow filter dyes can be selected from among those illustrated by Research Disclosure I, Section VIII. Absorbing and scattering materials, B. Absorbing materials. In elements of the instant invention, magenta colored filter materials are absent from IL2 and RU.

The antihalation layer unit AHU typically contains a processing solution removable or decolorizable light absorbing material, such as one or a combination of pigments and dyes. Suitable materials can be selected from among those disclosed in Research Disclosure I, Section VIII. Absorbing materials. A common alternative location for AHU is between the support S and the recording layer unit coated nearest the support.

The surface overcoats SOC are hydrophilic colloid layers that are provided for physical protection of the color negative elements during handling and processing. Each SOC also provides a convenient location for incorporation of addenda that are most effective at or near the surface of the color negative element. In some instances the surface overcoat is divided into a surface layer and an interlayer, the latter functioning as spacer between the addenda in the surface layer and the adjacent recording layer unit. In another common variant form, addenda are distributed between the surface layer and the interlayer, with the latter containing addenda that are compatible with the adjacent recording layer unit. Most typically the SOC contains addenda, such as coating aids, plasticizers and lubricants, antistats and matting agents, such as illustrated by Research Disclosure I, Section IX. Coating physical property modifying addenda. The SOC overlying the emulsion layers additionally preferably contains an ultraviolet absorber, such as illustrated by Research Disclosure I, Section VI. UV dyes/optical brighteners/luminescent dyes, paragraph (1).

Instead of the layer unit sequence of element SCN—I, alternative layer units sequences can be employed and are particularly attractive for some emulsion choices. Using high chloride emulsions and/or thin (<0.2 μm mean grain thickness) tabular grain emulsions all possible interchanges of the positions of BU, GU and RU can be undertaken without risk of blue light contamination of the minus blue records, since these emulsions exhibit negligible native sensitivity in the visible spectrum. For the same reason, it is unnecessary to incorporate blue light absorbers in the interlayers.

In the foregoing discussion the blue, green and red recording layer units are described as containing yellow, magenta and cyan image dye-forming couplers, respectively, as is conventional practice in color negative elements used for printing. The invention can be suitably applied to conventional color negative construction as illustrated. Color reversal film construction would take a similar form, with the exception that colored masking couplers would be completely absent; in typical forms, development inhibitor releasing couplers would also be absent. In preferred embodiments, the color negative elements are intended exclusively for scanning to produce three separate electronic color records. Thus the actual hue of the image dye produced is of no importance. What is essential is merely that the dye image produced in each of the layer units be differentiable from that produced by each of the remaining layer units. To provide this capability of differentiation it is contemplated that each of the layer units contain one or more dye image-forming couplers chosen to produce image dye having an absorption half-peak bandwidth lying in a different spectral region. It is immaterial whether the blue, green or red recording layer unit forms a yellow, magenta or cyan dye having an absorption half peak bandwidth in the blue, green or red region of the spectrum, as is conventional in a color negative element intended for use in printing, or an absorption half-peak bandwidth in any other convenient region of the spectrum, ranging from the near ultraviolet (300-400 nm) through the visible and through the near infrared (700-1200 nm), so long as the absorption half-peak bandwidths of the image dye in the layer units extend over substantially non-coextensive wavelength ranges. The term “substantially non-coextensive wavelength ranges” means that each image dye exhibits an absorption half-peak band width that extends over at least a 25 (preferably 50) nm spectral region that is not occupied by an absorption half-peak band width of another image dye. Ideally the image dyes exhibit absorption half-peak band widths that are mutually exclusive.

Instead of employing dye-forming couplers, any of the conventional incorporated dye image generating compounds employed in multicolor imaging can be alternatively incorporated in the blue, green and red recording layer units. Dye images can be produced by the selective destruction, formation or physical removal of dyes as a function of exposure. For example, silver dye bleach processes are well known and commercially utilized for forming dye images by the selective destruction of incorporated image dyes. The silver dye bleach process is illustrated by Research Disclosure I, Section X. Dye image formers and modifiers, A. Silver dye bleach.

It is also well known that pre-formed image dyes can be incorporated in blue, green and red recording layer units, the dyes being chosen to be initially immobile, but capable of releasing the dye chromophore in a mobile moiety as a function of entering into a redox reaction with oxidized developing agent. These compounds are commonly referred to as redox dye releasers (RDR's). By washing out the released mobile dyes, a retained dye image is created that can be scanned. It is also possible to transfer the released mobile dyes to a receiver, where they are immobilized in a mordant layer. The image-bearing receiver can then be scanned. Initially the receiver is an integral part of the color negative element. When scanning is conducted with the receiver remaining an integral part of the element, the receiver typically contains a transparent support, the dye image bearing mordant layer just beneath the support, and a white reflective layer just beneath the mordant layer. Where the receiver is peeled from the color negative element to facilitate scanning of the dye image, the receiver support can be reflective, as is commonly the choice when the dye image is intended to be viewed, or transparent, which allows transmission scanning of the dye image. RDR's as well as dye image transfer systems in which they are incorporated are described in Research Disclosure, Vol. 151, November 1976, Item 15162.

It is also recognized that the dye image can be provided by compounds that are initially mobile, but are rendered immobile during imagewise development. Image transfer systems utilizing imaging dyes of this type have long been used in previously disclosed dye image transfer systems. These and other image transfer systems compatible with the practice of the invention are disclosed in Research Disclosure, Vol. 176, December 1978, Item 17643, XXIII. Image transfer systems.

In a preferred embodiment the dye image is formed by the use of an incorporated developing agent, in reactive association with each color layer More preferably, the incorporated developing agent is a blocked developing agent.

In a preferred embodiment of this invention, the processed photographic film contains only limited amounts of color masking couplers, incorporated permanent Dmin adjusting dyes and incorporated permanent antihalation dyes. Generally, such films contain color masking couplers in total amounts up to about 0.6 mmol/m², preferably in amounts up to about 0.2 Mmol/m², more preferably in amounts up to about 0.05 mmol/m², and most preferably in amounts up to about 0.01 mmol/m².

The incorporated permanent Dmin adjusting dyes are generally present in total amounts up to about 0.2 mmol/m², preferably in amounts up to about 0.1 mmol/m², more preferably in amounts up to about 0.02 mmol/m², and most preferably in amounts up to about 0.005 mmol/m².

The incorporated permanent antihalation density is up to about 0.6 in blue, green or red density, more preferably up to about 0.3 in blue, green or red density, even more preferably up to about 0.1 in blue, green or red density and most preferably up to about 0.05 in blue, green or red Status M density.

Limiting the amount of color masking couplers, permanent antihalation density and incorporated permanent Dmin adjusting dyes serves to reduce the optical density of the films, after processing, in the 350 to 750 nm range, and thus improves the subsequent scanning and digitization of the imagewise exposed and processed films.

Overall, the limited Dmin and tone scale density enabled by controlling the quantity of incorporated color masking couplers, incorporated permanent Dmin adjusting dyes and antihalation and support optical density can serve to both limit scanning noise (which increases at high optical densities), and to improve the overall signal-to-noise characteristics of the film to be scanned. Relying on the digital correction step to provide color correction obviates the need for color masking couplers in the films.

Examples of blocked developers that can be used in photographic elements of the present invention include, but are not limited to, the blocked developing agents described in U.S. Pat. No. 3,342,599, to Reeves; Research Disclosure (129 (1975) pp. 27-30) published by Kenneth Mason Publications, Ltd., Dudley Annex, 12a North Street, Emsworth, Hampshire P010 7DQ, ENGLAND; U.S. Pat. No. 4,157,915, to Hamaoka et al.; U.S. Pat. No. 4,060,418, to Waxman and Mouming; and in U.S. Pat. No. 5,019,492. Particularly useful are those blocked developers described in U.S. application Ser. No. 09/476,234, filed Dec. 30, 1999, IMAGING ELEMENT CONTAINING A BLOCKED PHOTOGRAPICALLY USEFUL COMPOUND; U.S. application Ser. No. 09/475,691, filed Dec. 30, 1999, IMAGING ELEMENT CONTAINING A BLOCKED PHOTOGRAPHICALLY USEFUL COMPOUND; U.S. application Ser. No. 09/475,703, filed Dec. 30, 1999, IMAGING ELEMENT CONTAINING A BLOCKED PHOTOGRAPHICALLY USEFUL COMPOUND; U.S. application Ser. No. 09/475,690, filed Dec. 30, 1999, IMAGING ELEMENT CONTAINING A BLOCKED PHOTOGRAPHICALLY USEFUL COMPOUND; and U.S. application Ser. No. 09/476,233, filed Dec. 30, 1999, PHOTOGRAPHIC OR PHOTOTHERMOGRAPHIC ELEMENT CONTAINING A BLOCKED PHOTOGRAPHICALLY USEFUL COMPOUND.

In one embodiment of the invention, the blocked developer is preferably incorporated in one or more of the imaging layers of the imaging element. The amount of blocked developer used is preferably 0.01 to 5 g/m², more preferably 0.1 to 2 g/m² and most preferably 0.3 to 2 g/m² in each layer to which it is added. These may be color forming or non-color forming layers of the element. The blocked developer can be contained in a separate element that is contacted to the photographic element during processing.

After image-wise exposure of the imaging element, the blocked developer can be activated during processing of the imaging element by the presence of acid or base in the processing solution, by heating the imaging element during processing of the imaging element, and/or by placing the imaging element in contact with a separate element, such as a laminate sheet, during processing. The laminate sheet optionally contains additional processing chemicals such as those disclosed in Sections XIX and XX of Research Disclosure, September 1996, Number 389, Item 38957 (hereafter referred to as (“Research Disclosure I”). All sections referred to herein are sections of Research Disclosure I, unless otherwise indicated. Such chemicals include, for example, sulfites, hydroxylamine, hydroxamic acids and the like, antifoggants, such as alkali metal halides, nitrogen containing heterocyclic compounds, and the like, sequestering agents such as an organic acids, and other additives such as buffering agents, sulfonated polystyrene, stain reducing agents, biocides, desilvering agents, stabilizers and the like.

It is useful to include a melt-forming compound in a photothermographic element, such as in the imaging layers and in the antihalation layer or filter layer, as described. Combinations of melt-forming compounds or melt-formers can also be useful if desired. The term “melt-forming compound” as employed herein is intended to mean a compound that upon heating to the described processing temperature provides an improved reaction medium, typically a molten medium, wherein the described reaction combination can provide a better image. The exact nature of the reaction medium at processing temperatures described is not fully understood; however, it is believed that at reaction temperatures a melt occurs that permits the reaction components to better interact. Useful melt-forming compounds are typically separate components from the reaction combination, although the reaction combination can enter into the melt formation. Typically useful melt-forming compounds are amides, imides, cyclic ureas and triazoles that are compatible with other of the components of the materials of the invention. Useful melt-forming compounds are described, for example, in Research Disclosure, Vol. 150, October 1976, Item 15049 of LaRossa and Boettcher, published by Industrial Opportunities Ltd., Homewell, Havant, Hampshire, PO9 1EF, UK. As described, the filter layers of the invention can comprise a melt-forming compound if desired. Preferred melt-formers include salicylanilide and similar compounds.

A range of concentration of melt-forming compound or melt-forming compound combination is useful in the heat developable photographic materials described. The optimum concentration of melt-forming compound will depend upon such factors as the particular imaging material, desired image, processing conditions and the like.

Photothermographic elements as described can contain addenda that are known to aid in formation of a useful image. The photothermographic element can contain development modifiers that function as speed increasing compounds, sensitizing dyes, hardeners, anti-static agents, plasticizers and lubricants, coating aids, brighteners, such as described in Research Disclosure, December 1978, Item No. 17643 and Research Disclosure, June 1978, Item No. 17029.

A number of modifications of color negative elements have been suggested for accommodating scanning, as illustrated by Research Disclosure I, Section XIV. Scan facilitating features. These systems to the extent compatible with the color negative element constructions described above are contemplated for use in the practice of this invention.

It is also contemplated that the imaging element of this invention may be used with non-conventional sensitization schemes especially suitable for scanning. For example, instead of using imaging layers sensitized to the red, green, and blue regions of the spectrum, the light-sensitive material may have one white-sensitive layer to record scene luminance, and two color-sensitive layers to record scene chrominance. Following development, the resulting image can be scanned and digitally reprocessed to reconstruct the full colors of the original scene as described in U.S. Pat. No. 5,962,205. The imaging element may also comprise a pan-sensitized emulsion with accompanying color-separation exposure. In this embodiment, the developers of the invention would give rise to a colored or neutral image that, in conjunction with the separation exposure, would enable full recovery of the original scene color values. In such an element, the image may be formed by either developed silver density, a combination of one or more conventional couplers, or “black” couplers such as resorcinol couplers. The separation exposure may be made either sequentially through appropriate filters, or simultaneously through a system of spatially discreet filter elements (commonly called a “color filter array”).

The imaging element of the invention may also be a black and white image-forming material comprised, for example, of a pan-sensitized silver halide emulsion and a developer of the invention. In this embodiment, the image may be formed by developed silver density following processing, or by a coupler that generates a dye which can be used to carry the neutral image tone scale.

When conventional yellow, magenta, and cyan image dyes are formed to read out the recorded scene exposures following chemical development of conventional exposed color photographic materials, the response of the red, green, and blue color recording units of the element can be accurately discerned by examining their densities. Densitometry is the measurement of transmitted light by a sample using selected colored filters to separate the imagewise response of the RGB image dye forming units into relatively independent channels. It is common to use Status M filters to gauge the response of color negative film elements intended for optical printing, and Status A filters for color reversal films intended for direct transmission viewing. In integral densitometry, the unwanted side and tail absorptions of the imperfect image dyes leads to a small amount of channel mixing, where part of the total response of, for example, a magenta channel may come from off-peak absorptions of either the yellow or cyan image dyes records, or both, in neutral characteristic curves. Such artifacts may be negligible in the measurement of a film's spectral sensitivity. By appropriate mathematical treatment of the integral density response, these unwanted off-peak density contributions can be completely corrected providing analytical densities, where the response of a given color record is independent of the spectral contributions of the other image dyes. Analytical density determination has been summarized in the SPSE Handbook of Photographic Science and Engineering, W. Thomas, editor, John Wiley and Sons, New York, 1973, Section 15.3, Color Densitometry, pp. 840-848.

Image noise can be reduced, where the images are obtained by scanning exposed and processed color negative film elements to obtain a manipulatable electronic record of the image pattern, followed by reconversion of the adjusted electronic record to a viewable form. Image sharpness and colorfulness can be increased by designing layer gamma ratios to be within a narrow range while avoiding or minimizing other performance deficiencies, where the color record is placed in an electronic form prior to recreating a color image to be viewed. Whereas it is impossible to separate image noise from the remainder of the image information, either in printing or by manipulating an electronic image record, it is possible by adjusting an electronic image record that exhibits low noise, as is provided by color negative film elements with low gamma ratios, to improve overall curve shape and sharpness characteristics in a manner that is impossible to achieve by known printing techniques. Thus, images can be recreated from electronic image records derived from such color negative elements that are superior to those similarly derived from conventional color negative elements constructed to serve optical printing applications. The excellent imaging characteristics of the described element are obtained when the gamma ratio for each of the red, green and blue color recording units is less than 1.2. In a more preferred embodiment, the red, green, and blue light sensitive color forming units each exhibit gamma ratios of less than 1.15. In an even more preferred embodiment, the red and blue light sensitive color forming units each exhibit gamma ratios of less than 1.10. In a most preferred embodiment, the red, green, and blue light sensitive color forming units each exhibit gamma ratios of less than 1.10. In all cases, it is preferred that the individual color unit(s) exhibit gamma ratios of less than 1.15, more preferred that they exhibit gamma ratios of less than 1.10 and even more preferred that they exhibit gamma ratios of less than 1.05. In a like vein, it is preferred that the gamma ratios be greater than 0.8, more preferred that they be greater than 0.85 and most preferred that they be greater than 0.9. The gamma ratios of the layer units need not be equal. These low values of the gamma ratio are indicative of low levels of interlayer interaction, also known as interlayer interimage effects, between the layer units and are believed to account for the improved quality of the images after scanning and electronic manipulation. The apparently deleterious image characteristics that result from chemical interactions between the layer units need not be electronically suppressed during the image manipulation activity. The interactions are often difficult if not impossible to suppress properly using known electronic image manipulation schemes.

Elements having excellent light sensitivity are best employed in the practice of this invention. The elements should have a sensitivity of at least about ISO 50, preferably have a sensitivity of at least about ISO 100, and more preferably have a sensitivity of at least about ISO 200. Elements having a sensitivity of up to ISO 3200 or even higher are specifically contemplated. The speed, or sensitivity, of a color negative photographic element is inversely related to the exposure required to enable the attainment of a specified density above fog after processing. Photographic speed for a color negative element with a gamma of about 0.65 in each color record has been specifically defined by the American National Standards Institute (ANSI) as ANSI Standard Number PH 2.27-1981 (ISO (ASA Speed)) and relates specifically the average of exposure levels required to produce a density of 0.15 above the minimum density in each of the green light sensitive and least sensitive color recording unit of a color film. This definition conforms to the International Standards Organization (ISO) film speed rating. For the purposes of this application, if the color unit gammas differ from 0.65, the ASA or ISO speed is to be calculated by linearly amplifying or deamplifying the gamma vs. log E (exposure) curve to a value of 0.65 before determining the speed in the otherwise defined manner.

The present invention also contemplates the use of photothermographic elements of the present invention in what are often referred to as single use cameras (or “film with lens” units). These cameras are sold with film preloaded in them and the entire camera is returned to a processor with the exposed film remaining inside the camera. The one-time-use cameras employed in this invention can be any of those known in the art. These cameras can provide specific features as known in the art such as shutter means, film winding means, film advance means, waterproof housings, single or multiple lenses, lens selection means, variable aperture, focus or focal length lenses, means for monitoring lighting conditions, means for adjusting shutter times or lens characteristics based on lighting conditions or user provided instructions, and means for camera recording use conditions directly on the film. These features include, but are not limited to: providing simplified mechanisms for manually or automatically advancing film and resetting shutters as described at Skarman, U.S. Pat. No. 4,226,517; providing apparatus for automatic exposure control as described at Matterson et al, U S. Pat. No. 4,345,835; moisture-proofing as described at Fujimura et al, U.S. Pat. No. 4,766,451; providing internal and external film casings as described at Ohmura et al, U.S. Pat. No. 4,751,536; providing means for recording use conditions on the film as described at Taniguchi et al, U.S. Pat. No. 4,780,735; providing lens fitted cameras as described at Arai, U.S. Pat. No. 4,804,987; providing film supports with superior anti-curl properties as described at Sasaki et al, U.S. Pat. No. 4,827,298; providing a viewfinder as described at Ohmura et al, U.S. Pat. No. 4,812,863; providing a lens of defined focal length and lens speed as described at Ushiro et al, U.S. Pat. No. 4,812,866; providing multiple film containers as described at Nakayama et al, U.S. Pat. No. 4,831,398 and at Ohmura et al, U.S. Pat. No. 4,833,495; providing films with improved anti-friction characteristics as described at Shiba, U.S. Pat. No. 4,866,469; providing winding mechanisms, rotating spools, or resilient sleeves as described at Mochida, U.S. Pat. No. 4,884,087; providing a film patrone or cartridge removable in an axial direction as described by Takei et al at U.S. Pat. Nos. 4,890,130 and 5,063,400; providing an electronic flash means as described at Ohmura et al, U.S. Pat. No. 4,896,178; providing an externally operable member for effecting exposure as described at Mochida et al., U.S. Pat. No. 4,954,857; providing film support with modified sprocket holes and means for advancing said film as described at Murakami, U.S. Pat. No. 5,049,908; providing internal mirrors as described at Hara, U.S. Pat. No. 5,084,719; and providing silver halide emulsions suitable for use on tightly wound spools as described at Yagi et al, European Patent Application 0,466,417 A.

While the film may be mounted in the one-time-use camera in any manner known in the art, it is especially preferred to mount the film in the one-time-use camera such that it is taken up on exposure by a thrust cartridge. Thrust cartridges are disclosed by Kataoka et al U.S. Pat. No. 5,226,613; by Zander U.S. Pat. No. 5,200,777; by Dowling et al U.S. Pat. No. 5,031,852; and by Robertson et al U.S. Pat. No. 4,834,306. Narrow bodied one-time-use cameras suitable for employing thrust cartridges in this way are described by Tobioka et al U.S. Pat. No. 5,692,221.

Cameras may contain a built-in processing capability, for example a heating element. Designs for such cameras including their use in an image capture and display system are disclosed in Stoebe, et al., U.S. patent application Ser. No. 09/388,573 filed Sep. 1, 1999, incorporated herein by reference. The use of a one-time use camera as disclosed in said application is particularly preferred in the practice of this invention.

Photographic elements of the present invention are preferably imagewise exposed using any of the known techniques, including those described in Research Disclosure I, Section XVI. This typically involves exposure to light in the visible region of the spectrum, and typically such exposure is of a live image through a lens, although exposure can also be exposure to a stored image (such as a computer stored image) by means of light emitting devices (such as light emitting diodes, CRT and the like). The photothermographic elements are also exposed by means of various forms of energy, including ultraviolet and infrared regions of the electromagnetic spectrum as well as electron beam and beta radiation, gamma ray, x-ray, alpha particle, neutron radiation and other forms of corpuscular wave-like radiant energy in either non-coherent (random phase) or coherent (in phase) forms produced by lasers. Exposures are monochromatic, orthochromatic, or panchromatic depending upon the spectral sensitization of the photographic silver halide.

The elements as discussed above may serve as origination material for some or all of the following processes: image scanning to produce an electronic rendition of the capture image, and subsequent digital processing of that rendition to manipulate, store, transmit, output, or display electronically that image.

The color photothermographic elements of the present invention may contain any or all of the features discussed above, but are intended for different forms of processing. These types of systems will be described in detail below.

Type I: Photothermographic process systems where processing is initiated solely by the application of heat to the imaging element.

Type II: Low volume photothermographic systems, where film processing is initiated by contact to a processing solution, but where the processing solution volume is comparable to the total volume of the imaging layer to be processed. This type of system may include the addition of non solution processing aids, such as the application of a laminate layer that is applied at the time of processing.

Type I Photothermographic Systems can comprise photothermographic elements of the type described in Research Disclosure 17029 are included by reference. The photothermographic elements may be of type A or type B as disclosed in Research Disclosure I. Type A elements contain in reactive association a photosensitive silver halide, a reducing agent or developer, an activator, and a coating vehicle or binder. In these systems development occurs by reduction of silver ions in the photosensitive silver halide to metallic silver. Type B systems can contain all of the elements of a type A system in addition to a salt or complex of an organic compound with silver ion. In these systems, this organic complex is reduced during development to yield silver metal. The organic silver salt will be referred to as the silver donor. References describing such imaging elements include, for example, U.S. Pat. Nos. 3,457,075; 4,459,350; 4,264,725 and 4,741,992.

The photothermographic element comprises a photosensitive component that consists essentially of photographic silver halide. In the type B photothermographic material it is believed that the latent image silver from the silver halide acts as a catalyst for the described image-forming combination upon processing. In these systems, a preferred concentration of photographic silver halide is within the range of 0.01 to 100 moles of photographic silver halide per mole of silver donor in the photothermographic material.

The Type B photothermographic element comprises an oxidation-reduction image forming combination that contains an organic silver salt oxidizing agent. The organic silver salt is a silver salt which is comparatively stable to light, but aids in the formation of a silver image when heated to 80° C. or higher in the presence of an exposed photocatalyst (i.e., the photosensitive silver halide) and a reducing agent.

Suitable organic silver salts include silver salts of organic compounds having a carboxyl group. Preferred examples thereof include a silver salt of an aliphatic carboxylic acid and a silver salt of an aromatic carboxylic acid. Preferred examples of the silver salts of aliphatic carboxylic acids include silver behenate, silver stearate, silver oleate, silver laureate, silver caprate, silver myristate, silver palmitate, silver maleate, silver fumarate, silver tartarate, silver furoate, silver linoleate, silver butyrate and silver camphorate, mixtures thereof, etc. Silver salts which are substitutable with a halogen atom or a hydroxyl group can also be effectively used. Preferred examples of the silver salts of aromatic carboxylic acid and other carboxyl group-containing compounds include silver benzoate, a silver-substituted benzoate such as silver 3,5-dihydroxybenzoate, silver o-methylbenzoate, silver m-methylbenzoate, silver p-methylbenzoate, silver 2,4-dichlorobenzoate, silver acetamidobenzoate, silver p-phenylbenzoate, etc., silver gallate, silver tannate, silver phthalate, silver terephthalate, silver salicylate, silver phenylacetate, silver pyromellilate, a silver salt of 3-carboxymethyl-4-methyl-4-thiazoline-2-thione or the like as described in U.S. Pat. No. 3,785,830, and silver salt of an aliphatic carboxylic acid containing a thioether group as described in U.S. Pat. No. 3,330,663.

Silver salts of mercapto or thione substituted compounds having a heterocyclic nucleus containing 5 or 6 ring atoms, at least one of which is nitrogen, with other ring atoms including carbon and up to two hetero-atoms selected from among oxygen, sulfur and nitrogen are specifically contemplated. Typical preferred heterocyclic nuclei include triazole, oxazole, thiazole, thiazoline, imidazoline, imidazole, diazole, pyridine and triazine. Preferred examples of these heterocyclic compounds include a silver salt of 3-mercapto-4-phenyl-1,2,4 triazole, a silver salt of 2-mercaptobenzimidazole, a silver salt of 2-mercapto-5-aminothiadiazole, a silver salt of 2-(2-ethyl-glycolamido)benzotbiazole, a silver salt of 5-carboxylic-1-methyl-2-phenyl-4-thiopyridine, a silver salt of mercaptotriazine, a silver salt of 2-mercaptobenzoxazole, a silver salt as described in U.S. Pat. No. 4,123,274, for example, a silver salt of 1,2,4-mercaptothiazole derivative such as a silver salt of 3-amino-5-benzylthio-1,2,4-thiazole, a silver salt of a thione compound such as a silver salt of 3-(2-carboxyethyl)-4-methyl-4-thiazoline-2-thione as disclosed in U.S. Pat. No. 3,201,678. Examples of other useful mercapto or thione substituted compounds that do not contain a heterocyclic nucleus are illustrated by the following: a silver salt of thioglycolic acid such as a silver salt of a S-alkylthioglycolic acid (wherein the alkyl group has from 12 to 22 carbon atoms) as described in Japanese patent application 28221/73, a silver salt of a dithiocarboxylic acid such as a silver salt of ditbioacetic acid, and a silver salt of thioamide.

Furthermore, a silver salt of a compound containing an imino group can be used. Preferred examples of these compounds include a silver salt of benzotriazole and a derivative thereof as described in Japanese patent publications 30270/69 and 18146/70, for example a silver salt of benzotriazole or methylbenzotriazole, etc., a silver salt of a halogen substituted benzotriazole, such as a silver salt of 5-chlorobenzotriazole, etc., a silver salt of 1,2,4-triazole, a silver salt of 3-amino-5-mercaptobenzyl-1,2,4-triazole, of 1H-tetrazole as described in U.S. Pat. No. 4,220,709, a silver salt of imidazole and an imidazole derivative, and the like.

It is also possible to employ organic silver donors that are in the form of donors such as disclosed in commonly assigned USSN, hereby incorporated by reference in its entirety.

Silver salts complexes may also be prepared by mixture of aqueous solutions of a silver ionic species, such as silver nitrate, and a solution of the organic ligand to be complexed with silver. The mixture process may take any convenient form, including those employed in the process of silver halide precipitation. A stabilizer may be used to avoid flocculation of the silver complex particles. The stabilizer may be any of those materials known to be useful in the photographic art, such as, but not limited to, gelatin, polyvinyl alcohol or polymeric or monomeric surfactants.

The photosensitive silver halide grains and the organic silver salt are coated so that they are in catalytic proximity during development. They can be coated in contiguous layers, but are preferably mixed prior to coating. Conventional mixing techniques are illustrated by Research Disclosure, Item 17029, cited above, as well as U.S. Pat. No. 3,700,458 and published Japanese patent applications Nos. 32928/75, 13224/74, 17216/75 and 42729/76.

A second reducing agent in addition to, or in place of, the blocked developer may be included. The reducing agent for the organic silver salt may be any material, preferably organic material, that can reduce silver ion to metallic silver. Conventional photographic developers such as 3-pyrazolidinones, hydroquinones, p-aminophenols, p-phenylenediamines and catechol are useful, but hindered phenol reducing agents are preferred. The reducing agent is preferably present in a concentration ranging from 5 to 25 percent of the photothermographic layer. A wide range of reducing agents has been disclosed in dry silver systems.

An optimum concentration of organic reducing agent in the photothermographic element varies depending upon such factors as the particular photothermographic element, desired image, processing conditions, the particular organic silver salt and the particular oxidizing agent.

The photothermographic element can comprise a thermal solvent. Examples of useful thermal solvents include, for example, salicylanilide, phthalimide, N-hydroxyphthalimide, N-potassium-phthalimide, succinimide, N-hydroxy-1,8-naphthalimide, phthalazine, 1-(2H)-phthalazinone, 2-acetylphthalazinone, benzanilide, and benzenesulfonamide. Prior-art thermal solvents are disclosed, for example, in U.S. Pat. No. 6,013,420 to Windender. Examples of toning agents and toning agent combinations are described in, for example, Research Disclosure, June 1978, Item No. 17029 and U.S. Pat. No. 4,123,282.

Post-processing image stabilizers and latent image keeping stabilizers are useful in the photothermographic element. Any of the stabilizers known in the photothermographic art are useful for the described photothermographic element. Illustrative examples of useful stabilizers include photolytically active stabilizers and stabilizer precursors as described in, for example, U.S. Pat. No. 4,459,350. Other examples of useful stabilizers include azole thioethers and blocked azolinethione stabilizer precursors and carbamoyl stabilizer precursors, such as described in U.S. Pat. No. 3,877,940.

The photothermographic elements preferably contain various colloids and polymers alone or in combination as vehicles and binders and in various layers. Useful materials are hydrophilic or hydrophobic. They are transparent or translucent and include both naturally occurring substances, such as gelatin, gelatin derivatives, cellulose derivatives, polysaccharides, such as dextran, gum arabic and the like; and synthetic polymeric substances, such as water-soluble polyvinyl compounds like poly(vinylpyrrolidone) and acrylamide polymers. Other synthetic polymeric compounds that are useful include dispersed vinyl compounds such as in latex form and particularly those that increase dimensional stability of photographic elements. Effective polymers include water insoluble polymers of acrylates, such as alkylacrylates and methacrylates, acrylic acid, sulfoacrylates, and those that have cross-linking sites. Preferred high molecular weight materials and resins include poly(vinyl butyral), cellulose acetate butyrate, poly(methylmethacrylate), poly(vinylpyrrolidone), ethyl cellulose, polystyrene, poly(vinylchloride), chlorinated rubbers, polyisobutylene, butadiene-styrene copolymers, copolymers of vinyl chloride and vinyl acetate, copolymers of vinylidene chloride and vinyl acetate, poly(vinyl alcohol) and polycarbonates. When coatings are made using organic solvents, organic soluble resins may be coated by direct mixture into the coating formulations. When coating from aqueous solution, any useful organic soluble materials may be incorporated as a latex or other fine particle dispersion.

The layers of the photothermographic element are coated on a support by coating procedures known in the photographic art, including dip coating, air knife coating, curtain coating or extrusion coating using hoppers. If desired, two or more layers are coated simultaneously.

After imagewise exposure of the photothermographic element, the resulting latent image can be developed in a variety of ways. The simplest is by overall heating the element to thermal processing temperature. This overall heating merely involves heating the photothermographic element to a temperature within the range of about 90° C. to about 180° C. until a developed image is formed, such as within about 0.5 to about 60 seconds. By increasing or decreasing the thermal processing temperature a shorter or longer time of processing is useful. A preferred thermal processing temperature is within the range of about 100° C. to about 160° C. Heating means known in the photothermographic arts are useful for providing the desired processing temperature for the exposed photothermographic element. The heating means is, for example, a simple hot plate, iron, roller, heated drum, microwave heating means, heated air, vapor or the like.

It is contemplated that the design of the processor for the photothermographic element be linked to the design of the cassette or cartridge used for storage and use of the element. Further, data stored on the film or cartridge may be used to modify processing conditions or scanning of the element. Methods for accomplishing these steps in the imaging system are disclosed by Stoebe, et al., U.S. Pat. No. 6,062,746 and Szajewski, et al., U.S. Pat. No. 6,048,110, commonly assigned, which are incorporated herein by reference. The use of an apparatus whereby the processor can be used to write information onto the element, information which can be used to adjust processing, scanning, and image display is also envisaged. This system is disclosed in now allowed Stoebe, et al., U.S. patent application Ser. No. 09/206,914 filed Dec. 7, 1998 and Ser. No. 09/333,092 filed Jun. 15, 1999, which are incorporated herein by reference.

Thermal processing is preferably carried out under ambient conditions of pressure and humidity. Conditions outside of normal atmospheric pressure and humidity are useful.

In view of advances in the art of scanning technologies, it has now become natural and practical for photothermographic color films such as disclosed in EP 0762 201 to be scanned, which can be accomplished without the necessity of removing the silver or silver-halide from the negative, although special arrangements for such scanning can be made to improve its quality. See, for example, Simons U.S. Pat. No. 5,391,443.

Nevertheless, the retained silver halide can scatter light, decrease sharpness and raise the overall density of the film thus leading to impaired scanning. Further, retained silver halide can printout to ambient/viewing/scanning light, render non-imagewise density, degrade signal-to noise of the original scene, and raise density even higher. Finally, the retained silver halide and organic silver salt can remain in reactive association with the other film chemistry, making the film unsuitable as an archival media. Removal or stabilization of these silver sources are necessary to render the PTG film to an archival state.

Furthermore, the silver coated in the PTG film (silver halide, silver donor, and metallic silver) is unnecessary to the dye image produced. This silver is valuable and the desire to recover it is high.

Turning now to Type II processing, this refers to low volume processing (“substantially dry” or “apparently dry”) which is defined as phototothermographic processing where the volume of applied developer solution is between about 0.1 to about 10 times, preferably about 0.5 to about 10 times, the volume of solution required to swell the photographic element. This processing may take place by a combination of solution application, external layer lamination, and heating. The low volume processing system may contain any of the elements described above for Type I: Photothermographic systems. In addition, it is specifically contemplated that any components described in the preceding sections that are not necessary for the formation or stability of latent image in the origination film element can be removed from the film element altogether and contacted at any time after exposure for the purpose of carrying out photographic processing, using the methods described below.

The Type II photothermographic element may receive some or all of the following three treatments:
(I) Application of a solution directly to the film by any means, including spray, inkjet, coating, gravure process and the like.
(II) Soaking of the film in a reservoir containing a processing solution. This process may also take the form of dipping or passing an element through a small cartridge.
(III) Lamination of an auxiliary processing element to the imaging element. The laminate may have the purpose of providing processing chemistry, removing spent chemistry, or transferring image information from the latent image recording film element. The transferred image may result from a dye, dye precursor, or silver containing compound being transferred in a image-wise manner to the auxiliary processing element.

Heating of the element during processing may be effected by any convenient means, including a simple hot plate, iron, roller, heated drum, microwave heating means, heated air, vapor, or the like. Heating may be accomplished before, during, after, or throughout any of the preceding treatments 1-111. Heating may cause processing temperatures ranging from room temperature to 100° C.

Once yellow, magenta, and cyan dye image records have been formed in the processed photographic elements of the invention, conventional techniques can be employed for retrieving the image information for each color record and manipulating the record for subsequent creation of a color balanced viewable image. For example, it is possible to scan the photothermographic element successively within the blue, green, and red regions of the spectrum or to incorporate blue, green, and red light within a single scanning beam that is divided and passed through blue, green, and red filters to form separate scanning beams for each color record. A simple technique is to scan the photothermographic element point-by-point along a series of laterally offset parallel scan paths. The intensity of light passing through the element at a scanning point is noted by a sensor which converts radiation received into an electrical signal. Most generally this electronic signal is further manipulated to form a useful electronic record of the image. For example, the electrical signal can be passed through an analog-to-digital converter and sent to a digital computer together with location information required for pixel (point) location within the image. In another embodiment, this electronic signal is encoded with colorimetric or tonal information to form an electronic record that is suitable to allow reconstruction of the image into viewable forms such as computer monitor displayed images, television images, printed images, and so forth.

It is contemplated that many of imaging elements of this invention will be scanned prior to the removal of silver halide from the element. The remaining silver halide yields a turbid coating, and it is found that improved scanned image quality for such a system can be obtained by the use of scanners that employ diffuse illumination optics. Any technique known in the art for producing diffuse illumination can be used. Preferred systems include reflective systems, that employ a diffusing cavity whose interior walls are specifically designed to produce a high degree of diffuse reflection, and transmissive systems, where diffusion of a beam of specular light is accomplished by the use of an optical element placed in the beam that serves to scatter light. Such elements can be either glass or plastic that either incorporate a component that produces the desired scattering, or have been given a surface treatment to promote the desired scattering.

The elements of the invention can have density calibration patches derived from one or more patch areas on a portion of unexposed photographic recording material that was subjected to reference exposures, as described by Wheeler et al U.S. Pat. No. 5,649,260, Koeng at al U.S. Pat. No. 5,563,717, and by Cosgrove et al U.S. Pat. No. 5,644,647.

Illustrative systems of scan signal manipulation, including techniques for maximizing the quality of image records, are disclosed by Bayer U.S. Pat. No. 4,553,156; Urabe et al U.S. Pat. No. 4,591,923; Sasaki et al U.S. Pat. No. 4,631,578; Alkofer U.S. Pat. No. 4,654,722; Yamada et al U.S. Pat. No. 4,670,793; Klees U.S. Pat. Nos. 4,694,342 and 4,962,542; Powell U.S. Pat. No. 4,805,031; Mayne et al U.S. Pat. No. 4,829,370; Abdulwahab U.S. Pat. No. 4,839,721; Matsunawa et al U.S. Pat. Nos. 4,841,361 and 4,937,662; Mizukoshi et al U.S. Pat. No. 4,891,713; Petilli U.S. Pat. No. 4,912,569; Sullivan et al U.S. Pat. Nos. 4,920,501 and 5,070,413; Kimoto et al U.S. Pat. No. 4,929,979; Hirosawa et al U.S. Pat. No. 4,972,256; Kaplan U.S. Pat. No. 4,977,521; Sakai U.S. Pat. No. 4,979,027; Ng U.S. Pat. No. 5,003,494; Katayama et al U.S. Pat. No. 5,008,950; Kimura et al U.S. Pat. No. 5,065,255; Osamu et al U.S. Pat. No. 5,051,842; Lee et al U.S. Pat. No. 5,012,333; Bowers et al U.S. Pat. No. 5,107,346; Telle U.S. Pat. No. 5,105,266; MacDonald et al U.S. Pat. No. 5,105,469; and Kwon et al U.S. Pat. No. 5,081,692. Techniques for color balance adjustments during scanning are disclosed by Moore et al U.S. Pat. No. 5,049,984 and Davis U.S. Pat. No. 5,541,645.

### EXAMPLES

The following four silver halide emulsions, Emulsions 1 to 4, were prepared for testing in the subsequent Examples 1-4:

For Emulsion 1, the following six solutions were prepared:

| Solution A1 | |
|---|---|
| Gelatin | 50.0 g |
| Distilled water | 2939.9 g |

| Solution B1 | |
|---|---|
| NaBr | 875.63 g |
| Distilled water | 2608.43 g |

| Solution C1 | |
|---|---|
| AgNO₃ (5.722 M) | 2421.02 g |
| Distilled water | 1249.79 g |

| Solution D1 | |
|---|---|
| KI | 17.7 g |
| Distilled water | 194.75 g |

| Solution E1 | |
|---|---|
| Gelatin (phthalated) | 225 g |
| Distilled water | 2000 g |

| Solution F1 | |
|---|---|
| Gelatin (bone) | 205 g |
| Distilled water | 2000 g |

A reaction vessel equipped with a stirrer was charged with solution A1. The temperature was adjusted to 40° C. The pH was adjusted to 5.0. The temperature was then increased to 80° C. The pAg was adjusted to 7.9 after the temperature stabilized. With vigorous stirring, solutions B1 and C1 were added at a rate of 306.3 ml/min for 3.20 minutes maintaining the pAg at 7.9. Solutions B1 and C1 were then added simultaneously at a linearly accelerated rate from 7.06 ml/min to 32.5 ml/min in 58 minutes with the pAg maintained at 7.9. Solution D1 was delivered at once by manually dumping it into the reaction vessel in less than 5 seconds. The mixture was held for 10 minutes. Following this hold, solutions B1 and C1 were again added simultaneously at a linearly accelerated rate from 32.5 ml/min to 35.6 ml/min in 7 minutes with the pAg maintained at 7.9. The mixture was then cooled to 40° C. Solution E1 was added and stirred for 5 minutes. The pH was adjusted to 3.7 and the gel allowed to settle. The liquid layer was decanted and the depleted volume was restored with distilled water. The mixture was held until the temperature returned to 40° C. The pH was then adjusted to 4.3 and the mixture stirred for 5 minutes. The pH adjustment, settling, and decanting steps were repeated twice more. Solution F1 was added and the pH and pAg were adjusted to 6.2 and 8.2 respectively.

For Emulsion 2, the following six solutions were prepared:

| Solution A2 | |
|---|---|
| Gelatin | 100.0 g |
| Distilled water | 2903.16 g |

| Solution B2 | |
|---|---|
| NaBr | 1110.21 g |
| Distilled water | 3307.12 g |

| Solution C2 | |
|---|---|
| AgNO₃ (5.722 M) | 3073.24 g |
| Distilled water | 1586.48 g |

| Solution D2 | |
|---|---|
| KI | 22.41 g |
| Distilled water | 193.43 g |

| Solution E2 | |
|---|---|
| Gelatin (phthalated) | 270 g |
| Distilled water | 2500 g |

| Solution F2 | |
|---|---|
| Gelatin (bone) | 214 g |
| Distilled water | 2000 g |

A reaction vessel equipped with a stirrer was charged with solution A2. The temperature was adjusted to 40° C. The pH was adjusted to 5.0. The temperature was then increased to 80° C. The pAg was adjusted to 7.9 after the temperature stabilized. While vigorously stirring the reaction vessel, Solutions B2 and C2 were added at a rate of 72.8 ml/min for 3.20 minutes maintaining the pAg at 7.9. Solutions B2 and C2 were then added simultaneously at a linearly accelerated rate from 14.0 ml/min to 67.4 ml/min in 60.68 minutes with the pAg maintained at 7.9. Solution D2 was delivered at once by manually dumping it into the reaction vessel in less than 5 seconds. The mixture was held for 10 minutes. Following this hold, Solutions B2 and C2 were again added simultaneously at a linearly accelerated rate from 67.4 ml/min to 71.2 ml/min in 4.32 minutes with the pAg maintained at 7.9. The mixture was then cooled to 40° C. Solution E2 was added and stirred for 5 minutes. The pH was adjusted to 3.7 and the gel allowed to settle. The liquid layer was decanted and the depleted volume was restored with distilled water. The mixture was held until the temperature returned to 40° C. The pH was then adjusted to 4.3 and the mixture stirred for 5 minutes. The pH adjustment, settling, and decanting steps were repeated twice more. Solution F2 was added and the pH and pAg were adjusted to 6.2 and 8.2 respectively.

For Emulsion 3, the following seven solutions were prepared:

| Solution A3 | |
|---|---|
| Gelatin | 100.0 g |
| Distilled water | 2901.8 g |

| Solution B3 | |
|---|---|
| NaBr | 1054.06 g |
| Distilled water | 3139.84 g |

| Solution C3 | |
|---|---|
| AgNO3 (5.722 M) | 2424.55 g |
| Distilled water | 1509.66 g |

| Solution D3 | |
|---|---|
| NaBr | 2.75 g |
| Distilled water | 25.0 g |

| Solution E3 | |
|---|---|
| KI | 21.35 g |
| Distilled water | 199.9 g |

| Solution F3 | |
|---|---|
| Gelatin (phthalated) | 259.88 g |
| Distilled water | 2500 g |

| Solution G3 | |
|---|---|
| Gelatin (bone) | 252.89 g |
| Distilled water | 2000 g |

A reaction vessel equipped with a stirrer was charged with solution A3. The temperature was adjusted to 40° C. The pH was adjusted to 5.0. The temperature was then increased to 80° C. The pAg was adjusted to 7.9 after the temperature stabilized by manually adding Solution D3 in less than 5 seconds and holding for 4 minutes. While vigorously stirring the reaction vessel, Solutions B3 and C3 were added at a rate of 27.97 ml/min for 3.20 minutes maintaining the pAg at 7.9. Solutions B3 and C3 were then added simultaneously at a linearly accelerated rate from 13.99 ml/min to 67.52 ml/min in 60.85 minutes with the pAg maintained at 7.9. Solution E3 was delivered at once by manually dumping it into the reaction vessel in less than 5 seconds. The mixture was held for 10 minutes. Following this hold, Solutions B3 and C3 were again added simultaneously at a linearly accelerated rate from 67.37 ml/min to 71.02 ml/min in 4.15 minutes with the pAg maintained at 7.9. The mixture was then cooled to 40° C. Solution F3 was added and stirred for 5 minutes. The pH was adjusted to 3.7 and the gel allowed to settle. The liquid layer was decanted and the depleted volume was restored with distilled water. The mixture was held until the temperature returned to 40° C. The pH was then adjusted to 4.3 and the mixture stirred for 5 minutes. The pH adjustment, settling, and decanting steps were repeated twice more. Solution G3 was added and the pH and pAg were adjusted to 6.2 and 8.2 respectively.

The three above-prepared emulsions comprised octahedral grains. Average grain volume was determined by electrolytic grain analysis. The octahedral edge length for each emulsion is listed in Table 1 below.

TABLE 1

| | Edge Length |
|---|---|
| Emulsion | (μm) |
| 1 | 0.166 |
| 2 | 0.218 |
| 3 | 0.289 |

For Emulsion 4, a vessel equipped with a stirrer was charged with 5.8 liters of water containing 7.7 g of bone gelatin, and 27.1 g of sodium bromide at a temperature of 55° C. While keeping the temperature at 55° C., 48 mL of a 2.75 molar silver nitrate solution was added over a period of 1.42 minutes at a constant rate. The pBr was then controlled at 1.73 at 55° C. while a 2.75 molar silver nitrate solution and a 2.75 molar sodium bromide solution were added by double jet addition using a constant flow rate over a period of 3.9 minutes, consuming 0.36 moles of silver. 2900 g of an aqueous gelatin solution (containing 193 g of bone gelatin) was then added and allowed to stir for 10 minutes. The pBr was then controlled at 1.90 at 55° C. while a 2.75 molar silver nitrate solution and 2.75 molar sodium bromide solution were added at a constant flow rate over a period of 10 minutes, consuming 0.93 mole of silver. Thereafter the same solutions were added over a period of 27 minutes using an accelerated flow rate such that the final molar flow rate was 4 times that at the beginning, adding a total of 5.83 mole silver. A further 0.76 mole of silver was added over the next 2 minutes at a constant flow rate. During this time an aqueous solution containing a total of 0.0023 g of potassium hexachloroiridate was added to the reaction vessel. To this point 70% of the total silver used had been consumed. An aqueous solution of NaBr (3.7 molar) was then added with vigorous stirring until the contents of the reaction vessel were at a pBr of 1.08 at 55° C. Fine AgI grains (0.16 mole) were then added. The mixture in the reaction vessel was held for 2 minutes after which a 2.75 molar silver nitrate solution was added until a pBr of 2.56 was reached. The addition of silver nitrate was continued, at a controlled pBr of 2.56, until a total of 11.7 moles of silver had been used to prepare this emulsion. The emulsion was then cooled and desalted.

In Emulsion 4, tabular grains accounted for greater than 90 percent of total grain projected area. The mean grain ECD was 0.55 micron and the mean grain thickness was 0.08 micron.

In the following examples, the following sensitizing dyes were used:
D-1 Anhydro-5-chloro-9-ethyl-5′-phenyl-3′-93-sulfopropyl)oxacarbocyanine hydroxide, triethyl ammonium salt.
D-2 Anhydro-3,9-diethyl-3′-[N-(methylsulfonyl)carbamoylmethyl]-5-phenylbenzothiazolo oxacarbocyanine hydroxide.

### EXAMPLE 1

This Example shows sensitization, coating, exposure, and processing of fine-grain emulsions for evaluation in color negative photographic film. Samples of emulsions 1, 2, and 3 were sensitized according to the following procedure. Each sample was melted at 40° C. with stirring and received sodium thiocyanate at 200 mg/Ag mole and p-toluenethiosulfonate at 15 mg/Ag mole with a 5 minute hold after each addition. Spectral sensitizing dyes D-1 and D-2 in a 4:1 or 6:1 ratio were added. Following a 20 minute hold, the melts were sensitized with sodium carboxymethyl trimethyl thiourea and Au(I) bis (trimethyl triazoliumthiolate) tetrafluoroborate at levels ranging from 5,000 to 20,000 sulfur atoms/μm² and 2,500 to 10,000 Au atoms/μm² of grain surface area respectively. The melts were given a temperature ramp (5° C./3 minutes) to 70° C. and held for 20 minutes. After a temperature ramp down (2.2° C./minute) to 40° C., sodium 4-hydroxy-6-methyl-1,3,3a,7-tetraazaindene was added at 1.75 g/Ag mole.

Samples sensitized as described above were coated on a clear ESTAR™ film support with a gelatin subbing layer. Emulsion laydown was 0.86 g/m² of silver. This layer also contained 0.38 g/m² of a magenta coupler, surfactant, a paraphenylene diamine developer, a melt former, two silver donor compounds, and a total gelatin content of 2.69 g/m². The emulsion layer was overcoated with a 0.65 g/m² gelatin layer that also contained surfactant and 1.75% by weight of total coated gelatin of bis (vinylsulfonyl) methane hardener. (Format A)

As a comparison, Emulsions 1, 2 and 3 were also sensitized and coated in a format suitable for processing in process C-41.

Each melt received sodium thiocyanate at 200 mg/Ag mole. The melts that contained Emulsion 3 received p-toluenethiosulfonate at 15 mg/Ag mole. There was a 5-minute hold after each addition. All melts were then spectrally sensitized with a 4:1 ratio of D-1 and D-2. Following a 20 minute hold, the melts were chemically sensitized with sodium carboxymethyl trimethyl thiourea and Au(I) bis (trimethyl triazoliumthiolate) tetrafluoroborate at levels ranging from 20,000 to 125,000 sulfur atoms/μm² and 12,000 to 80,000 Au atoms/μm² of grain surface area. The melts were given a temperature ramp (5° C./3 minutes) to 70° C. and held for 20 minutes. After a temperature ramp down (2.2° C./minute) to 40° C., sodium 4-hydroxy-6-methyl-1,3,3a,7-tetraazaindene was added at 1.75 g/Ag mole.

Emulsions sensitized as described above were coated on a clear ESTAR™ film support with a gelatin subbing layer. Emulsion laydown was 0.81 g/m² of silver. This layer also contained 1.61 g/m² of a cyan coupler, surfactant, and a total gelatin content of 4.31 g/m². The emulsion layer was overcoated with a 0.86 g/m² gelatin layer that also contained surfactant and 1.75% by weight of total coated gelatin of bis (vinylsulfonyl) methane hardener. (Format B)

For photographic evaluation, each sample coating strip was exposed for 1 sec to a simulated daylight source through a Kodak Wratten filter number 9 and a step tablet ranging in density from 0 to 4 in 0.2 density steps. The strips coated in Format B were processed in C-41 developer for 3.25 minutes, bleached and fixed. The strips coated in Format A were processed at 158° C. for 18 seconds in a thermal processor. The relative log sensitivity was evaluated at a density of 0.15 above minimum density. The photographic speed is 100 times the antilog of the relative log sensitivity. The sensitizer amounts in k-atoms/micron squared and the corresponding results of photographic evaluation for Emulsion 1 are given in Table 2A (for photothermographic processing) and Table 2B (for non-photothermographic C-41 processing). In Tables 2A and 2B, the sulfur and gold levels are the formal levels of S and Au in k atoms/μm². Speeds were measured at a density of 0.15 above fog.]

TABLE 2A

| Sample | S | Au | Format A speed | Format A fog | Note |
|---|---|---|---|---|---|
| 1A | 5 | 2.5 | 228 | 0.18 | Invention |
| 1B | 7.5 | 3.8 | 248 | 0.26 | Invention |
| 1C | 10 | 3.8 | 248 | 0.28 | Invention |
| 1D | 20 | 7.5 | 222 | 1.34 | Comparison |

TABLE 2B

| Sample | S | Au | Format B speed | Format B fog | Note |
|---|---|---|---|---|---|
| 1A | 5 | 2.5 | 167 | 0.11 | Comparison |
| 1E | 20 | 12 | 217 | 0.067 | Comparison |
| 1F | 100 | 50 | 271 | 0.054 | Comparison |
| 1G | 125 | 63 | 272 | 0.056 | Comparison |

The results in Table 2A show that unacceptable fog levels are obtained with a sensitization of 7,500 atoms of gold when Emulsion 1 was coated in a photothermographic format and heat-developed. The optimum sensitization for photographic sensitivity with acceptable fog appears to be approximately 10,000 atoms of sulfur and 3,800 atoms of gold per square micron of emulsion surface area. In contrast to this discovery, the same emulsion when coated in a conventional format and processed according to the standard color negative film C-41 process requires about ten times the amount of sulfur and gold sensitizers to reach optimum photographic sensitivity as shown in Table 2B.

### EXAMPLE 2

Emulsion 2 was sensitized, coated, exposed and evaluated in formats A and B as described above and the results are given in Tables 3A and 3B.

In Table 3A and 3B, the sulfur and gold levels are the formal levels of S and Au in k atoms/μm². The speeds were measured at a density of 0.15 above fog.

TABLE 3A

| | | | Format A | Format A | |
|---|---|---|---|---|---|
| Sample | S | Au | speed | fog | Note |
| 2A | 10 | 3.7 | 273 | 0.16 | Invention |
| 2B | 10 | 5 | 274 | 0.18 | Invention |
| 2C | 20 | 7.5 | 280 | 1.15 | Comparison |

TABLE 3B

| | | | Format B | Format B | |
|---|---|---|---|---|---|
| Sample | S | Au | speed | fog | Note |
| 2D | 20 | 12 | 278 | 0.08 | Comparison |
| 2E | 125 | 50 | 322 | 0.09 | Comparison |
| 2F | 125 | 63 | 321 | 0.08 | Comparison |

The results in Table 3A show that unacceptable fog levels are obtained with a sensitization of 7,500 atoms of gold when Emulsion 2 was coated in a photothermographic format and heat-developed. The optimum sensitization of emulsion 2 for photographic sensitivity with acceptable fog appears to be approximately 10,000 atoms of sulfur and 5,000 atoms of gold per square micron of emulsion surface area. In contrast to this discovery, the same emulsion when coated in a conventional format and processed according to the standard color negative film C-41 process requires about ten times the amount of sulfur and gold sensitizers to reach optimum photographic sensitivity as shown in Table 3B.

### EXAMPLE 3

Emulsion 3 was sensitized, coated, exposed and evaluated in formats A and B as described above and the results are given in Tables 4A and 4B.

Table 4A. [The sulfur and gold levels are the formal levels of S and Au in k atoms/μm². Speedis speed at density of 0.15 above fog. Examples 3C and 3D are in cyan format.]

TABLE 4A

| Sample | S/Au | Au | Format A speed | Format A fog | Note |
|---|---|---|---|---|---|
| 3A | 10 | 3.7 | 311 | 0.14 | Invention |
| 3B | 10 | 5 | 312 | 0.16 | Invention |
| 3C | 5 | 5 | 319 | 0.20 | Invention |
| 3D | 10 | 5 | 311 | 0.19 | Invention |
| 3E | 20 | 10 | 321 | 0.94 | Comparison |

TABLE 4B

| Sample | S/Au | Au | Format B speed | Format B fog | Note |
|---|---|---|---|---|---|
| 3A | 10 | 3.7 | 167 | 0.11 | Comparison |
| 3F | 100 | 38 | 325 | 0.067 | Comparison |
| 3G | 125 | 63 | 322 | 0.067 | Comparison |
| 3H | 125 | 63 | 321 | 0.082 | Comparison |

The results in Table 4A show that unacceptable fog levels are obtained with a sensitization of 10,000 atoms of gold when emulsion 3 was coated in a photothermographic format and heat-developed. The optimum sensitization of emulsion 3 for photographic sensitivity with acceptable fog appears to be approximately 5,000 to 10,000 atoms of sulfur and 5,000 atoms of gold per square micron of emulsion surface area. In contrast to this discovery, the same emulsion when coated in a conventional format and processed according to the standard color negative film C-41 process requires about ten times the amount of sulfur and gold sensitizers to reach optimum photographic sensitivity as shown in Table 4B.

### EXAMPLE 4

To a sample of Emulsion 4 melted at 40° C. was added an aqueous solution containing 100 mg/Ag mole of sodium thiocyanate and an aqueous solution containing 35 mg/Ag mole of benzothiazolium tetrafluoroborate. Dye 1 was added at a level of 0.91 g/Ag mole and Dye 2 was added a level of 0.16 g/Ag mole. The gold and sulfur containing chemical sensitizers, potassium aurous dithiosulfate dihydrate and sodium thiosulfate penthydrate were then added at the levels described in Table 5. The emulsion was then digested at 60° C. for 15 minutes.

Emulsions sensitized as described above were coated on a clear ESTAR™ film support with a gelatin subbing layer. Emulsion laydown was 0.86 g/m² of silver. This layer also contained 0.54 g/m² of a magenta coupler, surfactant, 1.75 g/Ag mole of sodium 4-hydroxy-6-methyl-1,3,3a,7-tetraazaindene, and a total gelatin content of 4.31 g/m². The emulsion layer was overcoated with a 3.23 g/m gelatin layer that also contained surfactant and 1.75% by weight of total coated gelatin of bis (vinylsulfonyl) methane hardener. (Format C).

The same emulsions were also coated as above but in addition contained a paraphenylene diamine developer, a melt former, and two silver donor compounds, to facilitate thermal processing. (Format D).

The emulsions so coated were given a 0.01 second 5500° K daylight balanced exposure through a calibrated neutral step tablet and a Wratten™ 9 filter.

The coatings were processed either for 3 min 15 sec using Kodak Flexicolor C-41™ color negative processing, or for 18 seconds at 161° C. in a thermal processor, followed by a bleach/fix/wash cycle. The photographic speed was measured as the KIT speed, the Kontrast Independent Toe speed, a property that is known in the art and that is defined as the exposure where the density above Dmin is 0.20 times the average gradient from that point to 0.6 logE greater exposure. The ratio of speed/fog is a useful parameter for choosing the optimum sensitization.

Table 5 shows the results of a range of sulfur levels for the two processes. In Table 5, the sulfur and gold levels are the formal levels of S and Au in k atoms/μm². Speeds are measured as KIT Speed.

TABLE 5A

| | | | Format | Format | Speed/ | |
|---|---|---|---|---|---|---|
| Sample | S | Au | D speed | D fog | Fog Ratio | Note |
| 4A | 18.2 | 3.0 | 74 | 0.20 | 370 | Invention |
| 4B | 20.8 | 3.5 | 85 | 0.22 | 390 | Invention |
| 4C | 26.0 | 4.3 | 107 | 0.22 | 490 | Invention |
| 4D | 36.4 | 6.1 | 114 | 0.23 | 500 | Invention |
| 4E | 46.8 | 7.8 | 121 | 0.25 | 480 | Comparison |
| 4F | 80.8 | 13.4 | 131 | 0.32 | 410 | Comparison |
| 4G | 111.1 | 18.7 | 142 | 0.43 | 330 | Comparison |
| 4H | 143.6 | 24 | 145 | 0.56 | 260 | Comparison |

TABLE 5B

| | | | Format C | Format C | Speed/ | |
|---|---|---|---|---|---|---|
| Sample | S | Au | speed | fog | Fog Ratio | Note |
| 4I | 26.0 | 4.3 | 166 | 0.05 | 3300 | Comparison |
| 4J | 36.4 | 6.1 | 181 | 0.05 | 3600 | Comparison |
| 4K | 46.6 | 7.8 | 184 | 0.05 | 3700 | Comparison |
| 4L | 143.7 | 24 | 210 | 0.05 | 4200 | Comparison |

The results in Table 5A show that the optimum ratio of speed/fog in format D is obtained with a sensitization about 36,000 atoms of sulfur and 6,000 atoms of gold per square micron of emulsion surface area when the tabular-grain emulsion 4 was coated in a photothermographic format and heat-developed. Above 40,000 atoms S/μm², the Dmin for the thermal process begins to rapidly increase to unacceptable levels. In contrast to this discovery, the results in Table 5B show that the same emulsion, coated in a conventional format C and processed according to the standard color negative film C-41 process, is still increasing in speed/fog as the sensitizer levels are increased to about four times the amount of sulfur and gold sensitizers that provides optimum photographic sensitivity in the thermally processed format D.

The invention has been described in detail with particular reference to certain preferred embodiments thereof, but it will be understood that variations and modifications can be effected within the spirit and scope of the invention.

1. A color photothermographic element comprising a support, and over the support, at least one imaging layer comprising a hydrophilic colloid binder and a light-sensitive silver-halide emulsion, wherein the average surface area per silver halide grain is less than about 1 square micron, and wherein the emulsion is sensitized with an effective amount less than about 40,000 atoms of sulfur and with an effective amount less than about 6,000 atoms of gold per square micron of grain surface area.

2. The color photothermographic element of claim 1 wherein the silver-halide emulsion comprises grains of silver halide selected from the group consisting of silver iodobromide, silver bromide, silver chloride, silver chlorobromide, silver chloroiodobromide, and combinations thereof.

3. The color photothermographic element of claim 1 wherein the silver-halide emulsion comprises silver iodobromide grains.

4. The color photothermographic element of claim 1 wherein the silver-halide emulsion comprises silver halide grains at least 50% of the projected area of which is provided by silver-halide grains that are bounded primarily by (111) crystallographic planes.

5. The color photothermographic element of claim 1 wherein the silver-halide emulsion comprises silver-halide grains at least 50% of the projected area of which is provided by tabular grains with an aspect ratio of at least 2.

6. The color photothermographic element of claim 1 wherein the silver-halide emulsion is spectrally sensitized.

7. The color photothermographic element of claim 5 wherein the silver-halide emulsion comprises silver-halide grains at least 50% of grain projected area of which is provided by silver halide having a grain thickness greater than 0.06 microns.

8. The color photothermographic element of claim 1 wherein silver as silver halide relative to total silver, including both silver halide and organic silver donor, is present in said emulsion in an amount from 30 to 85% by weight.

9. The color photothermographic element of claim 1 wherein the imaging layer comprises, in addition to the light-sensitive silver-halide emulsion, a blocked developer, a thermal solvent, an image-dye-forming coupler, and a non-light-sensitive organic silver donor.

10. A method of processing a photothermographic element for accurately recording a scene as an image which element comprises a support and, coated on the support, a plurality of hydrophilic colloid layers comprising radiation sensitive silver-halide emulsion layers forming recording layer units for separately recording exposures in three different regions of the spectrum wherein at least one imaging layer comprises a hydrophilic colloid binder and a light-sensitive silver-halide emulsion, wherein the average surface area per silver halide grain is less than about 1 square micron, and wherein the emulsion is sensitized with an effective amount less than about 40,000 atoms of sulfur and with an effective amount less than about 6,000 atoms of gold per square micron of grain surface area, said method comprising thermally developing an imagewise exposed element and then scanning the element to form an electronic image representation of said imagewise exposure.

11. The method according to claim 10 further comprising the step of digitizing a first electronic image representation formed from the imagewise exposed, developed, and scanned photothermographic element to form a digital image.

12. The method according to claim 10 further comprising the step of modifying a first electronic image representation formed from the imagewise exposed, developed, and scanned photothermographic element to form a second electronic image representation.

13. The method according to claim 10 further comprising storing, transmitting, printing, or displaying an electronic image representation of an image derived from the imagewise exposed, developed, scanned photothermographic element.

14. The method according to claim 13, wherein said electronic image representation is a digital image.

15. The method according to claim 13, wherein printing the image is accomplished by electrophotography; inkjet; thermal dye sublimation; or by laser, LED or CRT printing to sensitized photographic paper.

16. The method according to claim 10 wherein the developing is accomplished in a dry state without the application of aqueous solutions.

17. A color photothermographic film comprising a support, and over the support, at least three light-sensitive layer units which have their individual sensitivities in different wavelength regions, at least one of the units being divided into at least two recording layer sub-units for increased exposure latitude, wherein each of the two layer sub-units comprise a light-sensitive silver-halide emulsion and binder;
wherein the silver-halide emulsion in one of the two recording layer sub-units has a relatively lower speed than the silver-halide emulsion in the other of the two recording layer subunits; and
wherein, in the lower-speed silver-halide emulsion, the average surface area per silver halide grain is less than about 1 square micron, and the emulsion is sensitized with an effective amount less than about 40,000 atoms of sulfur and with an effective amount less than about 6,000 atoms of gold per square micron of grain surface area.

18. The color photothermographic film of claim 17 wherein, in the relatively higher speed silver-halide emulsion, the average surface area per silver halide grain is greater than in the relatively lower speed silver-halide emulsion, and the emulsion is sensitized with an effective amount of sulfur and with an effective amount of gold, per square micron of grain surface area, that is greater than in the relatively lower speed silver-halide emulsion.

19. The color photothermographic film of claim 17 wherein, in the relatively higher speed silver-halide emulsion, the average surface area per silver halide grain is substantially greater than in the relatively lower speed silver-halide emulsion, and the emulsion is sensitized with an effective amount of sulfur and with an effective amount of gold, per square micron of grain surface area, that is at substantially greater than in the relatively lower speed layer sub-unit.

20. The color photothermographic film of claim 18 wherein, in the relatively higher speed silver-halide emulsion, the average surface area per silver halide grain is greater than about 1 square micron, and the emulsion is sensitized with an effective amount greater than about 40,000 atoms of sulfur and with an effective amount greater than about 6,000 atoms of gold per square micron of grain surface area.
